(19) United States
(12) Patent Application Publication
(10) Pub. No.: US 2013/0338309 A1
(43) Pub. Date: Dec. 19, 2013

(54) RESINS FROM UNSATURATED POLYESTERS AND POLYSILAZANES AND DUROPLASTIC REACTION RESIN MOULDING MATERIALS PRODUCED THEREFROM

(71) Applicants: Monika Bauer, Konigs-Wusterhausen (DE); Sebastian Steffen, Berlin (DE); Daniel Decker, Liederbach (DE); Frank Richter, Frankfurt (DE)

(72) Inventors: Monika Bauer, Konigs-Wusterhausen (DE); Sebastian Steffen, Berlin (DE); Daniel Decker, Liederbach (DE); Frank Richter, Frankfurt (DE)

(73) Assignees: Clariant Finance (BVI) Limited, Road Town, Tortola (VG); Fraunhofer-Gesellschaft zur Foerderung der angewandten Forschung e.V., Muenchen (DE)

(21) Appl. No.: 13/825,929

(22) PCT Filed: Sep. 13, 2011
(86) PCT No.: PCT/EP2011/065890

§ 371 Date: Aug. 29, 2013

(30) Foreign Application Priority Data
Sep. 29, 2010 (DE) 102010046914.9

(51) Int. Cl. C08G 63/91; C08K 7/06

(52) U.S. Cl. CPC C08G 63/918; C08K 7/06
USPC 524/604; 525/445

(57) ABSTRACT

The invention relates to an unsaturated polyester resin containing a polyester or a polyester mixture, produced from at least one unsaturated dicarboxylic acid and at least one diol; and at least one silazane which is accessible for copolymerization with a C═C double bond of the dicarboxylic acid. The invention also relates to an unsaturated polyester resin moulding material which can be obtained or is obtained by cross-linking an unsaturated polyester resin as defined above. Said moulding material can optionally contain reinforcing materials. Said unsaturated polyester resin can be produced using the following steps: (a) a polyester from at least one diol and at least one unsaturated dicarboxylic acid is provided; (b) at least one silazane which is accessible for copolymerization which a C═C double bond of the dicarboxylic acid is provided; (c) the components are mixed according to (a) and (b). The unsaturated polyester resin moulding material can be produced from the above-mentioned polyester resin by hardening thereof by means of a radical initiator.

The present invention relates to reaction resins from unsaturated polyesters in combination with copolymerizable, preferably vinyl group-based silazanes as cross-linking agents and optionally an additional reactive diluting agent in which the mixture is provided in dissolved form. Furthermore, the invention relates to reaction resin moulding materials from said reaction resins. The hardened masses feature better flame retardancies and satisfactory glass transition temperatures.

Unsaturated polyester resins have been disclosed long ago and are based on an invention by Ellis & Foster in 1937. Normally, flame-retardant polyester resins are produced with the addition of flame retardants such as aluminum trihydroxide or ammonium phosphate, such as disclosed e.g. in EP 848032. Normally, the addition of these kinds of agents increases the viscosity, thus having a detrimental effect on the processability of the resins, as well as resulting in lower mechanical load bearing capacities of components produced from the resins, especially in connection with very high filling material contents in the range of more than 50% by weight of filling material relative to the filled resin.

The object of the invention is to provide unsaturated polyester resins which can be used to produce moulded materials with better char resistance. Furthermore, the object of the invention is to provide corresponding moulded materials.

The object is solved by using a mixture as polyester reaction resin which comprises at least one polyester and at least one silazane containing one or a plurality of C═C double bonds and which can be polymerized into the product via said double bonds in connection with the polymerization of the polyester double bonds.

Unsaturated polyesters are the polycondensation product of unsaturated dicarboxylic acids, optionally in combination with saturated, often aromatic dicarboxylic acids or their respective anhydrides and diols. α,β-unsaturated dicarboxylic acids such as maleic acid or maleic acid anhydride or fumaric acid are typically used. However, it is also possible to use itaconic acid, mesaconic acid or citraconic acid. The distance between the double bonds is relevant with respect to the future properties of the unsaturated polyester resin and its reactivity. For this reason, saturated dicarboxylic acids are additionally used in some cases in order to reduce the double bond density. Furthermore, saturated dicarboxylic acids are used to control additional properties of the resin parts and the future components. Phthalic acid or phthalic acid anhydride, isophthalic acid, terephthalic acid or adipinic acid are predominantly used for this purpose. However, all other saturated dicarboxylic acids can also be used as additive to reduce the double bond density.

Different types of di- and/or trifunctional alcohols are used as alcohol component, wherein difunctional alcohols are normally preferred to prevent the branching of the polyester molecule. Typically, saturated alcohols such as for example 1,2-propanediol, ethylene-glycol, diethylene glycol or dipropylene glycol are used as diol, wherein diols with a longer chain length and/or a different distance between the chain links can obviously be used instead. Neopentyl glycol, 1,3-butanediol as well as bis-ethoxylated and bis-propoxylated bisphenol A are frequently used as special diols to convey special properties to the polyester molecule. This list is obviously not complete and can be supplemented with virtually any aliphatic dialcohol. If the presence of trifunctional alcohols is desired, they are normally used in mixture with diols.

The polycondensation reaction between the acid (anhydride) and alcohol groups may or may not take place with the use of a catalyst (e.g. Zn or Sn compounds). An inhibitor such as hydroquinone is often added to the starting material for the unsaturated polyester or to the polyester itself to prevent premature polymerization. Purely linear products are generated if exclusively dicarboxylic acids and dialcohols are used as starting materials, wherein branching may however occur as a result of secondary reactions.

The unsaturated polyesters are provided in different forms. Depending on the used components and polycondensation conditions, they can either be viscous and tough or hard and brittle. They are soluble in different solvents.

Due to the existing double bonds, the unsaturated polyesters are accessible to a radical polymerization reaction (polyaddition). The latter can be used to cross-link the polyesters with each other. For this purpose, additives are normally used which are themselves accessible to a radical polyaddition reaction and which can cross-link the linear polyester structures during co-polymerization. Since said additives are at the same time preferably used as solvent for the polyester, they are referred to as “reactive diluting agents”, provided they are capable of performing said task. Depending on the quantity of reactive diluting agent, the viscosity of the unsaturated polyester resin can be set lower or higher. Styrene is normally used as reactive diluting agent. Other possible reactive diluting agents include e.g. acrylates such as methyl methacrylate or styrene derivatives. This list is not complete.

A polymerization inhibitor such as hydroquinone can equally be added to the reactive diluting agent to prevent premature polymerization.

The mixture of polyester and reactive diluting agent is also known as reaction resin or unsaturated polyester resin (in short: UP resin).

A radical initiator is used for hardening (cross-linking) the unsaturated polyester resins.

They are compounds which dissociate into radicals when exposed to heat or radiation, said radicals subsequently activating the radical copolymerization. Once activated, the latter can no longer be stopped. Hydroperoxides, peroxides and peresters as well as other compounds with the necessary properties are normally used for thermohardening. Methyl is ethyl ketone peroxide (MEKP) is commonly used for industrial hardening purposes. This is often done in connection with an accelerator (e.g. a cobalt, manganese or iron naphthenate or octanoate, as well as a tertiary amine) to allow hardening at room temperature. In principle, all known radical initiators can be used. The appropriate initiator is selected with respect to the desired processing properties of the polyester resins and the chosen hardening temperatures (the addition of accelerator in combination with MEKP allows cold hardening). However, radiation chemical methods such as e.g. electron beam or UV hardening are also possible in addition to thermohardening. A number of initiator systems are available for this purpose.

Gelling is the first step of the hardening process; in it, the growing molecule chains are no longer able to diffuse, the resulting moulding material is no longer flowing and should therefore have its final shape. Complete hardening follows, which is normally associated with a certain degree of shrinkage.

Unsaturated polyester resins are processed in many different ways. The most common ones are hand-lay-up/spray-lay-up (application or spraying on of the resin onto reinforcing materials, followed by the manual incorporation of the resins using rollers and drums), the RTM (resin transfer moulding) method, the SMC (sheet moulding compound)/BMC (bulk moulding compound) method and other processing methods. In principle, all unsaturated polyester resins can be processed in this manner, although a precise adjustment to match the respective method is often required.

The unsaturated polyester resin moulded materials are thermosetting polymers. They are predominantly used in the ship building, automotive and railway industries. Other areas of application include case materials for the electronics industry, wind turbine generator rotor blades and other large and small-scale uses in a variety of technical fields. In the process, they are often used in a fibre-reinforced form. Glass fibres are commonly used as fibres; carbon fibres are used less commonly.

The silazane mentioned above used for the invention is a monomeric silazane, an oligosilazane and/or a polysilazane and comprises at least one C═C double bond. Accordingly, in the present invention, the term “silazane” shall comprise monomeric, oligomeric and polymeric silazanes as well as mixtures of silazanes which can be monomeric, oligomeric and/or polymeric, unless otherwise provided for the specific case. According to the invention, “oligosilazanes” and “oligomeric silazanes” means silazanes having 2 to 10 silicon atoms. “Polysilazanes” and “polymeric silazanes” are silazanes having at least 11 silicon atoms.

Silazanes, especially polysilazanes have gained increasing significance in recent years for a number of reasons. They have been incorporated into phenolic resins and epoxy resins and their insertion reaction in isocyanates was examined, wherein poly-urea silazanes are created. The latter are of interest in particular as starting materials for the production of ceramics.

For the purpose of the present invention, the at least one silazane can be added to the polyester as single co-monomer; however, it is often used in mixture with a common reactive diluting agent. This is the rule when the silazane is unable to dissolve the polyester completely or adequately and a reaction in the molten mass is impossible or not desirable.

A vinyl group-based silazane is preferably used as C═C double bond-based silazane. The latter can comprise a single, two or a plurality of vinyl groups and bring about a corresponding wider or closer meshed cross-linkage.

The formula of the simplest silazane body is R₃Si—NR—SiR₃ with any organic R residues. In the process, the organic residue bonded to the nitrogen is preferably hydrogen, and in some cases also an alkyl residue such as methyl (usually containing 1-4 carbon atoms). For the purpose of the invention, every silazane of said structure shall be deemed suitable as long as at least one R residue has a C═C double bond and is preferably a vinyl residue.

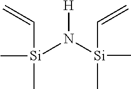

is one example. In this illustration, the lines depicting the bonds at the silicon represent substituents selected from hydrogen and linear-chain, branched or cyclical, substituted or—preferably—unsubstituted alkyl, aryl, arylalkyl, alkylaryl, alkenylaryl or arylalkenyl, preferably hydrogen or C₁-C₄ alkyl. It is particularly preferred that no, only one or at most two lines depicting bonds are provided for hydrogen. Instead of the vinyl residue, a different residue with a C═C double bond could be bonded to the silicon in each of said cases, e.g. an allyl or styryl residue. Instead of the hydrogen substituent on the nitrogen, the nitrogen atom could carry an alkyl residue with preferably 1 to 4 carbon atoms or a substituted or (preferably) unsubstituted phenyl residue in each of said cases.

Oligomers and polymeric silazanes contain at least two Si—N groups, which can again be substituted as described for the silazane above. Because both the silicon atoms as well as the nitrogen atoms can be substituted differently depending on the starting materials, a large variety of substances is created which can also be provided as mixture with different molecule lengths depending on the manufacturing method. In the process, the mentioned silazanes can be provided as chains; however, they often have a ring structure.

Generally, the oligomeric and polymeric silazanes to be used according to the invention can be depicted as a composition comprising one or a plurality of the following required or optional components:

—Si(R²)(R³)—N(R⁴)— component A (required)

wherein

R² is an organic residue containing at least one C═C double bond, preferably vinyl, R³ can be identical or different in several components A within the same molecule and means hydrogen or straight-chain, branched or cyclical, substituted or—preferably—unsubstituted alkyl, alkenyl, aryl, arylalkyl, alkylaryl, alkenylaryl or arylalkenyl, preferably is hydrogen, phenyl or C₁-C₄-alkyl and particularly preferably is hydrogen or methyl, and R⁴ can be identical or different in several components A within the same molecule and means hydrogen, C₁-C₄-alkyl or phenyl, preferably hydrogen or methyl and particularly preferably hydrogen,

—Si(R³)(R⁵)—N(R⁴)— component B (optional)

wherein

R³ and R⁴ are defined identical as for component A and R⁵ can be identical or different in several components A within the same molecule and in rare cases means hydrogen, otherwise straight-chain, branched or cyclical, substituted or—preferably—unsubstituted alkyl, alkenyl, aryl, arylalkyl, alkylaryl, alkenylaryl or arylalkenyl, preferably is C₁-C₄-alkyl and particularly preferably is methyl,

—Si(R³)(R⁶)—N(R⁴)— component C (optional)

wherein

R³ and R⁴ are defined as above and R⁶ represents a cross-linkage site to any other component of the components mentioned herein, wherein the cross-linkage to the silicon atom of the other component is achieved via an alkylene group, in particular an ethylene group,

—Si(R³)(R⁵)—N(R⁷)— component D (optional)

wherein R³ and R⁵ are defined as above and R⁷ represents a cross-linkage site to any other component of the components mentioned herein, wherein the cross-linkage is achieved via a direct bond of the nitrogen atom of component D to the silicon atom of the other component,

—Si(R³)(R⁵)P—Si(R³)(R⁵)—N(R⁴)— component E (optional)

wherein R³, R⁴ and R⁵ are defined as above and R³ and R⁵ can have an identical or different meaning within the same component and P is an alkylene group having 1 to 12 carbon atoms, preferably ethylene,

—Si(R³)(R⁵)—N(R⁴)—C(O)—N(R⁴)— component F (optional)

wherein R³, R⁴ and R⁵ are defined as above and can have an identical or different meaning within the same component.

Each of the mentioned components can be provided bonded to identical components on both sides (if the silazanes are ring-shaped, they exclusively contain these types of components); alternatively, it is provided at the periphery within the molecule. In this case, either the silicon atom carries an additional residue R³ with the meaning mentioned above, or the nitrogen atom carries an additional residue R⁶, with one of the following meanings:
R³ is defined as above,
Si(R³)₃, wherein the three residues R³ can be identical or different and have the meaning mentioned above, wherein preferably none of the residues represents a hydrogen atom, and
Si(R³)₂—X—R⁷—Si(R³)_{q}(OR³)_{3-q}, wherein the residues R³ can be identical or different and have the meaning mentioned above, while preferably being hydrogen or alkyl, in particular C₁-C₄-alkyl, if they are provided bonded to the silicon, and alkyl, in particular C₁-C₄-alkyl, if they are provided in the form of an OR³ group, X is either O or NR⁴ with the meaning mentioned above, R⁷ represents a single bond or a substituted or—preferably—unsubstituted, straight-chain, branched or cyclical alkylene group and q is 0, 1, 2 or 3.

The number of components and their relative proportion can fluctuate arbitrarily; the total number is often in the range of up to 500, and if necessary, considerably higher. The components can be distributed regularly or arranged in blocks; however, they are preferably provided randomized within the atoms.

Examples include oligomers/polymers having the components hereinafter written in square brackets, whose relative proportion to each other within the molecule is in each case indicated behind the square bracket:

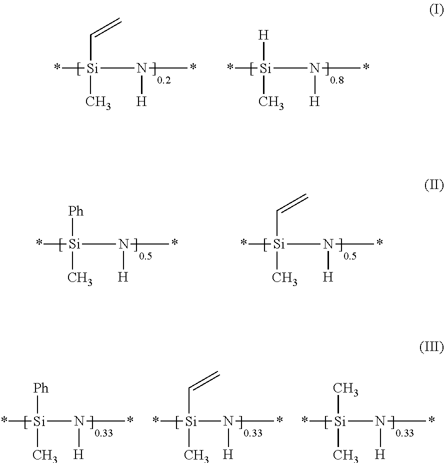

and based on mixtures of polysilazanes of the formula (I) additionally:

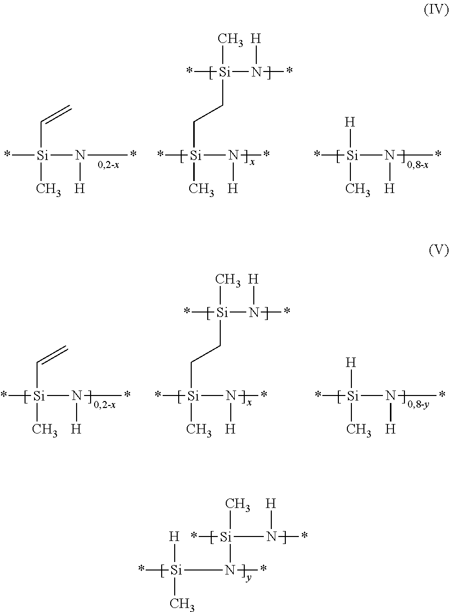

Some silazanes of the structures mentioned above are available on the market and can be manufactured based on standard procedures, in particular the ammonolysis of monohalogen silanes, such as described for instance in U.S. Pat. No. 4,395,460 and the literature cited therein. In the process, silazanes of the formula (I) are created e.g. as a result of the conversion of a monohalogen silane, wherein the indices n and o are zero, the index m means 1 and R⁵ means Si(R¹)(R^{2′})(R^{3′}). The organic residues are not removed during the reaction.

Likewise, it is possible to ammonolyze mono-, di- or trisilanes in a pressure apparatus in liquid ammonia analogous to U.S. Pat. No. 6,329,487 B1 of the Kion Corporation and to obtain silazanes of the general formula (I) in this fashion.

If halogen silanes having at least one Si—H bond are converted alone and/or in combination with di- or trihalogen silanes in an excess of liquid anhydrous ammonia and left in said medium for an extended period of time, polymerization products are formed over time in the environment which became acidic due to the developing ammonium halide salt or the corresponding acid as a result of the exhaustive reaction of Si—H bonds, in which the indices m, n and o have a higher value and/or a different proportion than previously, possibly catalysed by the presence of dissolved and ionized ammonium halide.

As well, it is described in U.S. Pat. No. 6,329,487 B1 that corresponding polymerization products can be obtained with the exposure to sodium dissolved in ammonia.

Furthermore, U.S. Pat. No. 4,621,383 and WO 87/05298 describe the possibility to synthesize polysilanes by means of transition metal-catalysed reactions.

The suitable selection of organic substituents on the silicon atom of the silane or a mixture of corresponding starting silanes allows the creation of a multitude of silazanes of the formula (I) using said methods, wherein index o is zero, and where a mixture of linear and chain-shaped polymers often develops.

For more information about the reaction mechanism, please refer to the thesis of Michael Schulz at the Research Centre Karlsruhe, Institute for Materials Research entitled

“Microstructuring of pre-ceramic polymers by means of deep UV and X-ray lithography”, November 2003, FZKA 6901. In it, the manufacture of silazanes of the formula (I) is described as well, wherein the index o is zero and the silicon atoms in the blocks with the indices m and n carry different substituents.

In it, reference is also made to the manufacture of urea silazanes: if monofunctional isocyanates are added to silazanes, an insertion reaction of the NCO group into N—H bonds takes place, with the formation of an urea group [see the silazanes of formula (II) described above]. In addition, please refer to U.S. Pat. No. 6,165,551, U.S. Pat. No. 4,929,704 and U.S. Pat. No. 3,239,489 with respect to the manufacture of urea silazanes and poly(-urea silazanes).

The manufacture of compounds of the formula (III) (alkoxy-substituted silazanes) is disclosed in U.S. Pat. No. 6,652,978 B2. For the manufacture of said compounds, monomeric or oligomeric/polymeric silazanes of the formula (I), wherein o is zero, can be converted with amino or hydroxyl group-based alkoxysilanes, for example 3-aminopropyl-triethoxysilane.

A manufacturing procedure for compounds of the formula (I) where o is unequal to zero is presented specifically using the ammonolysis of 1,2-Bis(dichloromethylsilyl-ethane in the thesis of G. Motz (G. Motz, thesis, University of Stuttgart, 1995). According to S. Kokott and G. Motz, “Modification of the polycarbosilazane ABSE using multi-walled carbon nanotubes for the manufacture of spinnable masses”, Material Science and Engineering 2007, 38 (11), 894-900, the manufacture of a special representative of said compounds, ABSE, is achieved by means of hydrolysis and ammonolysis of a mixture containing MeHSiCl₂ and MeViSiCl₂.

In turn, the person skilled at the art is easily able to produce N-alkyl-substituted silazanes in the same fashion, by bringing the corresponding halogen silanes to react with alkyl amines, such as described for example in U.S. Pat. No. 4,935,481 and U.S. Pat. No. 4,595,775.

The polysilazane of the formula (IV) is a processed form of a polyvinyl silane of the formula (I), containing differently sized molecules. Low-boiling components are removed from it by means of distillation. A thermal cross-linkage via the double bonds and the Si—H groups takes place to a certain degree in the process during the so-called hydrolysis. Polysilazanes of the formula (V) are formed if conversion in the presence of a fluoride catalyst takes place after the distillation, wherein dehydrocoupling occurs with the new formation of Si—N—Si groups under the formation of H₂. Products of the formula (VI) can be obtained if said type of fluoride-catalysed reaction is performed using a mixture of polysilazanes of the formula (I), which contains low-boiling components.

An unsaturated polyester is mixed with a silazane or a silazane mixture as defined above for the manufacture of polyester resins according the invention. In principle, the invention is suitable for any type of unsaturated polyester resin. However, it is preferred that the polyester has a relatively low acid number, because this enhances the compatibility between the components. In addition, there is a risk associated with very high acid numbers that the Si—N groups disintegrate under the removal of NH₃, which can result in intense undesirable secondary reactions. Therefore, an acid number of 20 mg/KOH should not be exceeded under any circumstances; preferably, the number is below 15 mg/KOH and particularly preferably under 10 mg/KOH.

If the silazane is unable to dissolve the polyester, it is additionally preferred to either add a solvent or a reactive diluting agent. Indeed, the reaction can also take place in the molten mass, but said conversion is more difficult to control. A reactive diluting agent is preferable to a solvent, because it can be fully incorporated into the developing network during the radical polymerization, while the subsequent removal of the solvent from the network is necessary. The typically often used styrene is a suitable reactive diluting agent.

In principle, the quantitative proportion of unsaturated polyester to silazane and optionally to the reactive solvent is not critical, because all mentioned components are involved in the radical polymerization and are statistically incorporated into the developing network. Networks with different densities are obtained with the use of different quantitative relations. Moreover, the properties of the polyester resin moulded materials can be controlled with the ratios of aliphatic/linear or cross-linked structures (e.g. with the use of corresponding silazanes) and aromatic structures (e.g. with the use of styrene as reactive diluting agent), in order to prevent a high network density (with the consequence of a potentially undesirably low glass transition temperature), as known to the person skilled at the art. It is e.g. possible to use polyester or polyester +reactive diluting agent and silazane at a quantitative proportion (weight/weight) of 1:100 to 100:1, preferably of 1:10 to 10:1 and more preferably of 1:5 to 5:1. If reactive diluting agent is present, a quantitative proportion (weight/weight) between polyester and reactive diluting agent of 1:10 to 10:1, preferably 1:5 to 5:1 is advantageous. Mixtures with a proportion between 4:1 and 1:1 are often sold commercially.

To obtain bubble-free products, the mixture should be degassed prior to processing, for example at approx. 200 mbar, unless it contains a low-boiling solvent.

It can be processed in any fashion, for instance as described above for polyester resins of the prior art or as casting resin. One essential exemplary embodiment of the invention relates to fibre-reinforced polyester resin moulded masses. They can be produced e.g. by means of the known RTM (resin transfer moulding) method. With this method, a stack of dry fibrous tissue is placed into a tool and shaped by means of a press. Next, it is impregnated with the low-viscosity resin according to the invention, usually be means of pressure, or—e.g. with the VARTM (vacuum assisted RTM)—by means of a vacuum in the closed tool and subsequently hardened, which is normally done with the exposure to heat, thus creating the corresponding component.

The reactive resin mixture can be hardened in the known fashion. The use of low-oxidizing peroxides is advantageous, as it is known to the person skilled at the art. Favourable results can be achieved with tertiary butyl perbenzoate.

The hardened masses are characterized by a glass temperature of up to 155° C. The char resistance increases considerably (based on the examples, the MAHRE value of pure resin specimens decreases by approx. 30% compared with similar polyesters without silazane). It is particularly advantageous if the char residues are considerably higher (as much as approximately 30-50 percent by mass of material is found after the moulded materials according to the invention have been charred, while the char residue of common UP moulded materials is as low as approximately 1 percent by mass). Moreover, the specimens still have a residual strength after being charred. In the case of fibrous carbon tissue-RTM specimens, it was possible to reduce the MAHRE value to a value of lower than 100 kW/m². In addition, an extremely low absolute heat release of 10 MJ/m² was achieved. The loss of mass during the charring process is as low as 15%.

### EXEMPLARY EMBODIMENTS

### Example 1

50 parts by weight of a polyester comprising 1 mol of maleic acid anhydride, 0.5 mol of phthalic acid anhydride, 0.84 mol of propylene glycol and 0.75 mol of dipropylene glycol with endcapping of the COOH terminal groups through 1-Octanol (isomolar addition at an acid number of 25 mg KOH/g), with a final acid number of 10 mg KOH/g, dissolved in 40 percent by weight of styrene, were thoroughly mixed using a glass rod with 50 parts by weight of a silazane having the approximate formula (IV) (manufactured with the distillation of a mixture of a vinyl silazane which consisted of 20% —Si(CH₃)(CH═CH₂)—NH— components and 80% —Si(H)(CH═CH₂)—NH— components, wherein thermal cross-linkage in part occurred via the double bonds and the Si—H groups (so-called hydrosilylation)) and 0.5 parts by weight of tertiary Butyl perbenzoate, wherein gas bubbles rose. After mixing it thoroughly, the mixture was deventilated at 200 mbar, until no visible gas bubbles were present any more. Next, it was poured into a plate mould and fully hardened at 160-180° C.

The data illustrated in Table 1 were measured.

### Example 2

Example 1 was repeated with the change that 66.6 parts by weight of the polyester resin, 33.3 parts by weight of the silazane and 0.66 parts by weight of tertiary Butyl perbenzoate were used.

The data illustrated in Table 1 were measured.

### Example 3

66.6 parts by weight of an unsaturated polyester comprising 1 mol of fumaric acid, 0.4 mol of neopentyl glycol, 0.606 mol of bispropoxylated bisphenol A and 0.051 mol of propylene glycol with endcapping of the COOH terminal groups through 1-Octanol (isomolar addition at an acid number of 25 mg KOH/g) having a final acid number of 4 mg KOH/g dissolved in 50% by weight of styrene were mixed with 33.3 parts by weight of the silazane according to example 1 as well as 0.66 parts by weight of tertiary Butyl perbenzoate and fully dried as described in example 1.

A bubble-free pure resin plate was created.

### Example 4

A mixture was produced analogous to example 3 and processed by means of RTM. Fibrous carbon tissue was used as reinforcing material. The hardening was carried out analogous to the conditions in example 1. The characterization supplied the data illustrated in Table 1.

### Comparative examples 5 and 6

The resins of examples 1 and 3 were polymerized without the addition of silazane, but otherwise as described in these examples. The glass transition temperature of the obtained moulded materials is illustrated in Table 1.

TABLE 1

| | | | | THR | TSR | | |
|---|---|---|---|---|---|---|---|
| | TTI | HRRpeak | MARHE | [MJ/ | [m²/ | Δm | T_{G} |
| | [s] | [kW/m²] | [kW/m²] | m²] | m²] | [%] | [° C.] |
| Example 1 | 45 | 595 | 277 | 102 | 5200 | 51 | ca. |
| | | | | | | | 60-70 |
| Example 2 | 43 | 732 | 319 | 114 | 6400 | 66 | 90 |
| Example 4 | 42 | 243 | 95 | 10 | 400 | 15 | 155 |
| Comparative | | | | | | | 106 |
| example 5 | | | | | | | |
| Comparative | | | | | | | 170 |
| example 6 | | | | | | | |

Abbreviations:
TTI = Time of ignition
HRRpeak = Heat release rate peak
MARHE = Maximum average rate of heat emission
THR = Total heat release
TSR = Total smoke released
Δm indicates the loss of mass in % as a result of the charring, i.e. 100% - Δm indicates the mass of the char residue (CR).

1. An unsaturated polyester resin, containing
(a) a polyester or a polyester mixture, produced from
at least one unsaturated dicarboxylic acid and
at least one diol
and
(b) at least one silazane, which is accessible for copolymerization with a C═C double bond of the dicarboxylic acid.

2. An unsaturated polyester resin according to claim 1, further comprising
(c) a reactive diluting agent.

3. An unsaturated polyester resin according to claim 2, wherein the reactive diluting agent is an unsubstituted or substituted styrene.

4. An unsaturated polyester resin according to any one of the preceding claims, further comprising
(d) at least one radical initiator.

5. An unsaturated polyester resin according to any one of the preceding claims, wherein the polyester has an acid number of less than 12 mg/KOH.

6. An unsaturated polyester resin according to any one of the preceding claims, wherein the silazane which is accessible for copolymerization with a C═C double bond of the dicarboxylic acid comprises one or a plurality of C═C double bonds.

7. An unsaturated polyester resin according to claim 6, wherein the silazane which is accessible for copolymerization with a C═C double bond of the dicarboxylic acid comprises vinyl groups bound to silicon atoms.

8. An unsaturated polyester resin according to claim 7, wherein at least part of the mentioned silazane comprises the component —Si(R)(CH═CH₂)—NH— where R equals H or methyl.

9. An unsaturated polyester resin moulding material which can be obtained or is obtained by cross-linking an unsaturated polyester resin according to any one of claims 1 to 8.

10. An unsaturated polyester resin moulding material according to claim 9, containing at least one reinforcing material, in particular reinforcing fibres.

11. A method for the production of an unsaturated polyester resin according to any one of claims 1 to 8, characterized by the steps
(a) provision of a polyester from at least one diol and at least one unsaturated dicarboxylic acid as defined in any one of claims 1 to 5,
(b) provision of at least one silazane which is accessible for copolymerization with a C═C double bond of the dicarboxylic acid as defined in any one of claims 1 and 6 to 8,
(c) mixing of the components according to (a) and (b).

12. A method according to claim 11, wherein the polyester and/or the silazane is/are provided dissolved in a solvent or a reactive diluting agent and/or wherein a polymerization inhibitor is added to the polyester.

13. A method for the production of an unsaturated polyester resin moulding material according to claim 9, comprising
(a) the provision of an unsaturated polyester resin as defined in any one of claims 1 to 8 and
(b) the hardening of the unsaturated polyester resin by means of a radical initiator under the formation of the moulding material.

14. A method for the production of an unsaturated polyester resin moulding material containing reinforcing fibres according to claim 10, comprising
(a) the provision of an unsaturated polyester resin as defined in any one of claims 1 to 8,
(b) the incorporation of fibres into the unsaturated polyester resin or the impregnation or coating of fibres or the filling of a mould containing the polyester resin as well as
(c) the hardening of the unsaturated polyester resin by means of a radical initiator under the formation of the moulding material.

15. A method according to claim 13 or 14, wherein the unsaturated polyester resin is provided with its production according to claim 11 or 12.

16. A method according to any one of claims 13 to 15, wherein the unsaturated polyester resin is degassed before being converted into a form in which it is hardened.
